(19) United States
(12) Patent Application Publication
(10) Pub. No.: US 2014/0362187 A1
(43) Pub. Date: Dec. 11, 2014

(54) STEREOSCOPIC IMAGE DISPLAY CONTROL DEVICE, IMAGING APPARATUS INCLUDING THE SAME, AND STEREOSCOPIC IMAGE DISPLAY CONTROL METHOD

(71) Applicant: FUJIFILM Corporation, Tokyo (JP)

(72) Inventor: Kenkichi HAYASHI, Saitama-shi (JP)

(21) Appl. No.: 14/466,298

(22) Filed: Aug. 22, 2014

Related U.S. Application Data
(63) Continuation of application No. PCT/JP2012/081150, filed on Nov. 30, 2012.

(30) Foreign Application Priority Data
Feb. 23, 2012 (JP) 2012-037646

(51) Int. Cl. H04N 13/04; H04N 13/00; H04N 13/02; G02B 27/22; G06T 19/20

(52) U.S. Cl. CPC H04N 13/0497; G02B 27/2214; G06T 19/20; H04N 13/0203; H04N 13/0007
USPC 348/46; 345/419; 345/173

(57) ABSTRACT

A system control unit 11 includes a first step of causing a stereoscopic image to be displayed in an enlarged scale according to an instruction on a display device 23, and a second step of determining, when the stereoscopic image is enlarged at a magnification according to the instruction, whether or not a parallax amount of the enlarged stereoscopic image displayed on the display device 23 is greater than a threshold value, in which in the first step, when the instruction for enlarging the stereoscopic image at the magnification at which the parallax amount is greater than the threshold value is made, the enlarged stereoscopic image to be displayed on the display device 23 after the instruction is finished becomes the enlarged stereoscopic image in the enlarged scale at the magnification at which the parallax amount is not greater than the threshold value.

### CROSS REFERENCE TO RELATED APPLICATION

This is a continuation of International Application No. PCT/JP2012/081150 filed on Nov. 30, 2012, and claims priority from Japanese Patent Application No. 2012-037646, filed on Feb. 23, 2012, the entire disclosures of which are incorporated herein by reference.

### BACKGROUND

1. Technical Field

The present invention relates to a stereoscopic image display control device, an imaging apparatus including the same and a stereoscopic image display control method.

2. Related Art

A television receiver capable of displaying a stereoscopic image (a 3D image) is spreading, and a digital camera (a stereoscopic image imaging apparatus) capable of photographing the stereoscopic image of a subject is showing a sign of its spread. When the stereoscopic image captured by such a stereoscopic image imaging apparatus is displayed on, for example, a display unit of the stereoscopic image imaging apparatus or an external display device (e.g., a large screen TV), a user may want to display the displayed stereoscopic image in an enlarged scale.

FIG. 10 is a view illustrating an exemplary stereoscopic image. A stereoscopic image 300 illustrated in FIG. 10 is constituted by right-eye images and left-eye images. The right-eye images include a main subject 200R, and a background 100R positioned at the back of the main subject 200R, and the left-eye images include a main subject 200L displayed at a position shifted with respect to the main subject 200R by a parallax amount Po, and a background 100L displayed at a position shifted with respect to the background 100R by a parallax amount Pb.

FIG. 11 is a view illustrating the stereoscopic image 300 of FIG. 10 in an enlarged scale. As illustrated in FIG. 11, when the stereoscopic image 300 is enlarged, the parallax amount Pb and the parallax amount Po are also increased according to a magnification. Until the parallax amount Pb and the parallax amount Po are increased to some extent, it is possible to make the stereoscopic image 300 stereoscopic without burden on, for example, eyes of an observer. However, when the parallax amount Pb and the parallax amount Po are extremely increased, the parallax of the main subject or the background becomes too large, resulting in a great burden on, for example, eyes of the observer.

Patent Literature 1 (JP-A-20014-349736) discloses an apparatus which determines if a parallax amount of a stereoscopic image is within a stereoscopically visible parallax range, and provides, for example, an alert to a user, or adjusts the parallax amount of the stereoscopic image when determining that the parallax amount is out of the parallax range.

SUMMARY OF INVENTION

### Technical Problem

However, in the apparatus disclosed in Patent Literature 1, the alert is displayed when an enlargement operation is performed until a parallax amount of the stereoscopic image becomes not suitable for stereoscopic vision. Thus, the alert is displayed after the stereoscopic image having a large parallax amount has already been displayed. This causes a burden on eyes of an observer who has seen the stereoscopic image having the large parallax amount.

In the apparatus disclosed in Patent Literature 1, the parallax amount is adjusted when an enlargement operation is performed until a parallax amount of the stereoscopic image becomes not suitable for stereoscopic vision. However, when the parallax amount has been extremely increased, the parallax amount is still too large to be suitable for stereoscopic vision even though the adjustment is performed. This also causes a burden on eyes of an observer.

The present invention has been made by taking the above described circumstances into account, and an object thereof is to provide a stereoscopic image display control device which may reduce a burden on an observer when a stereoscopic image is enlarged, and an imaging apparatus including the same and a stereoscopic image display control method.

### Solution to Problem

A stereoscopic image display control device of the present, which causes a stereoscopic image based on a plurality of image data photographed at different viewpoints to be displayed on a stereoscopic image display device, includes: an enlargement instruction receiving unit that receives an enlargement instruction for enlarging the stereoscopic image displayed on the stereoscopic image display device; an enlargement display control unit that causes the stereoscopic image to be displayed in an enlarged scale according to the enlargement instruction on the stereoscopic image display device; and a parallax amount determination unit that determines, when the stereoscopic image is enlarged at a magnification according to the enlargement instruction, whether or not a parallax amount of the enlarged stereoscopic image displayed on the stereoscopic image display device is greater than a threshold value, in which when the enlargement instruction for enlarging the stereoscopic image at the magnification at which the parallax amount is greater than the threshold value is made, the enlargement display control unit causes the enlarged stereoscopic image to be displayed on the stereoscopic image display device after the enlargement instruction is finished to become the enlarged stereoscopic image in the enlarged scale at the magnification at which the parallax amount is not greater than the threshold value.

According to the configuration, when an enlargement instruction is finished, an enlarged stereoscopic image having a parallax amount not greater than the threshold value is displayed on a stereoscopic image display device. Thus, it is possible to reduce a burden on an observer when the stereoscopic image is enlarged. In the stereoscopic image display control device of the present invention, the enlarged stereoscopic image displayed on the stereoscopic image display device after the enlargement instruction is finished is obtained by enlarging the stereoscopic image at a magnification at which the parallax amount is not greater than the threshold value. That is, in the enlarged stereoscopic image displayed on the stereoscopic image display device after the enlargement instruction is finished, the parallax amount itself is not adjusted. Thus, the enlarged stereoscopic image is highly correlated with the stereoscopic image before enlargement. Meanwhile, in the apparatus disclosed in Patent Literature 1, an enlarged stereoscopic image with an adjusted parallax amount is displayed. Thus, a correlation between the enlarged stereoscopic image displayed after the enlargement instruction is finished and the stereoscopic image before enlargement, is reduced. Accordingly, according to the present invention, the quality of an enlarged stereoscopic image displayed on the stereoscopic image display device is not lowered by an enlargement instruction, but a burden on an observer may be reduced when a stereoscopic image is enlarged.

An imaging apparatus of the present invention includes: the stereoscopic image display control device; the stereoscopic image display device; an imaging unit that captures a subject; and an image processing unit that generates the plurality of image data from a plurality of image signals captured by the imaging unit.

A stereoscopic image display control method of the present invention for causing a stereoscopic image based on a plurality of image data photographed at different viewpoints to be displayed on a stereoscopic image display device, the method includes: an enlargement instruction receiving step of receiving an enlargement instruction for enlarging the stereoscopic image displayed on the stereoscopic image display device; an enlargement display control step of causing the stereoscopic image to be displayed in an enlarged scale according to the enlargement instruction on the stereoscopic image display device; and a parallax amount determination step of determining, when the stereoscopic image is enlarged at a magnification according to the enlargement instruction, whether or not a parallax amount of the enlarged stereoscopic image displayed on the stereoscopic image display device is greater than a threshold value, in which in the enlargement display control step, when the enlargement instruction for enlarging the stereoscopic image at the magnification at which the parallax amount is greater than the threshold value is made, the enlarged stereoscopic image to be displayed on the stereoscopic image display device after the enlargement instruction is finished becomes the enlarged stereoscopic image in the enlarged scale at the magnification at which the parallax amount is not greater than the threshold value.

### Advantageous Effects of Invention

According to the present invention, it is possible to provide a stereoscopic image display control device which may reduce a burden on an observer when a stereoscopic image is enlarged, and an imaging apparatus including the same and a stereoscopic image display control method.

### BRIEF DESCRIPTION OF DRAWINGS

FIG. 1 is a view for explaining an exemplary embodiment of the present invention, which schematically illustrates a configuration of an imaging apparatus.

FIG. 2 is a flow chart for explaining an operation of a digital camera 1 illustrated FIG. 1 during of an enlargement operation of a stereoscopic image.

FIGS. 3A to 3D are views illustrating an exemplary screen displayed on a stereoscopic image display device 23 during the operation based on the flow chart illustrated in FIG. 2.

FIG. 4 is a flow chart for explaining a modified example of an operation of the digital camera 1 illustrated in FIG. 1 during of an enlargement operation of a stereoscopic image.

FIGS. 5A to 5E are views illustrating an exemplary screen displayed on the stereoscopic image display device 23 during the operation based on the flow chart of the modified example illustrated in FIG. 4.

FIG. 6 is a view illustrating a screen displayed on the stereoscopic image display device 23 in the digital camera 1 illustrated in FIG. 1 when an enlargement instruction of a stereoscopic image is received.

FIG. 7 is a view illustrating a screen displayed on the stereoscopic image display device 23 in the digital camera 1 illustrated in FIG. 1 when an enlargement instruction of a stereoscopic image is received.

FIG. 8 is a view illustrating an external appearance of a smart phone 200 as an exemplary photographing apparatus of the present invention.

FIG. 9 is a block diagram illustrating the configuration of the smart phone 200 illustrated in FIG. 8.

FIG. 10 is a view illustrating an exemplary stereoscopic image.

FIG. 11 is a view illustrating the stereoscopic image illustrated in FIG. 10 in an enlarged scale.

### DESCRIPTION OF EMBODIMENTS

Hereinafter, an exemplary embodiment of the present invention will be described with reference to drawings.

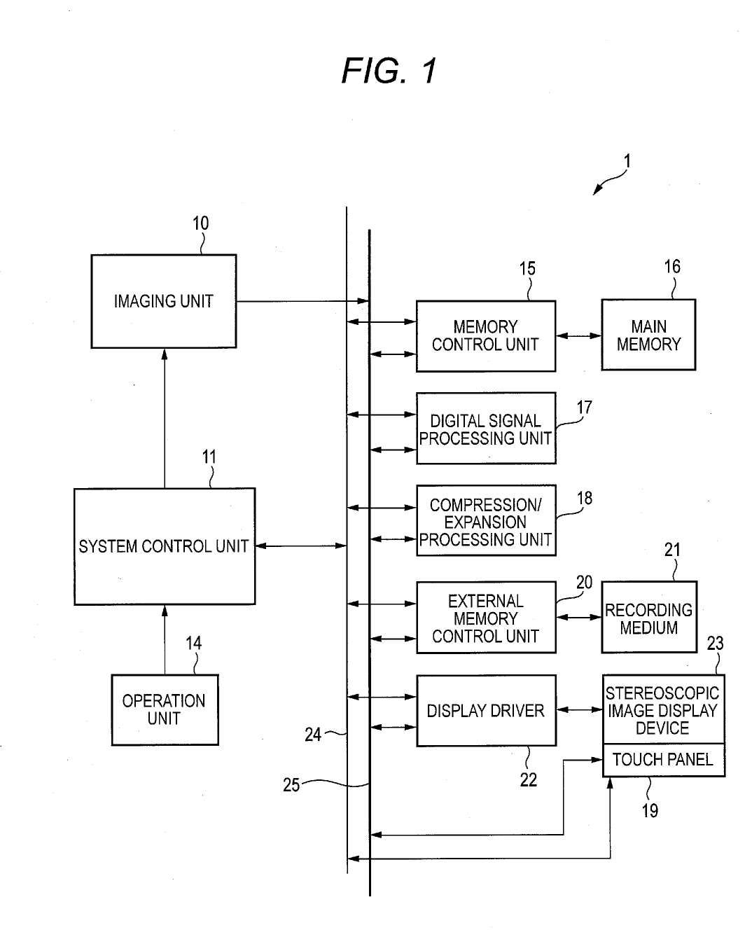

FIG. 1 is a view for explaining an exemplary embodiment of the present invention, which schematically illustrates a configuration of an electronic device provided with a stereoscopic image display control device. Examples of the electronic device may include an imaging apparatus such as, for example, a digital camera and a digital video camera, and a cellular phone (a smart phone) and a tablet-type computer each of which is mounted with a camera. Here, as an example, a digital camera will be described.

The illustrated digital camera 1 includes an imaging unit 10, a system control unit 11 mainly constituted by a CPU (a central processing unit; a computer), an operation unit 14 including, for example, a shutter button by which an instruction signal from a user is input to the system control unit 11, a memory control unit 15, a main memory 16, a digital signal processing unit 17, a compression/expansion processing unit 18, an external memory control unit 20 connected to a detachable recording medium 21, a display driver 22, a stereoscopic image display device 23, and a touch panel 19.

The imaging unit 10 may obtain a plurality of captured image signals (e.g., two captured image signals in this case) photographed at different viewpoints.

For example, the imaging unit 10 includes two imaging devices arranged to be spaced apart from each other and photographing optical systems provided at front sides of the two imaging devices, respectively, and obtains two captured image signals photographed at different viewpoints from the two imaging devices through a single photographing. The imaging unit 10 may include one imaging device and one photographing optical system provided at the front side of the imaging device, and may obtain two captured image signals photographed at different viewpoints from the one imaging device when photographing is performed several times by moving the imaging device and the photographing optical system. The configuration of the imaging unit 10 is not limited to these configurations. The imaging 10 is operated by an instruction of the system control unit 11.

The main memory 16 includes an RAM used as a work memory and an ROM which stores various data, and reading, writing and erasing of data are performed under a control of the memory control unit 15.

The digital signal processing unit 17 performs, for example, an interpolation operation, a gamma correction operation, or an RGB/YC conversion processing on captured image signals output from the imaging unit 10 so as to generate photographed image data. Two captured image data generated by the digital signal processing unit 17, which have been obtained by photographing at different viewpoints, are associated with each other to generate stereoscopic image data. The stereoscopic image data are, for example, MPO format data in accordance with a standard of Camera & Imaging Products Association (CIPA).

The compression/expansion processing unit 18 compresses the stereoscopic image data generated by the digital signal processing unit 17 into a JPEG format or expands the compressed image data.

The stereoscopic image display device 23 displays a stereoscopic image based on the stereoscopic image data (two captured image data photographed at different viewpoints). The stereoscopic image display device 23 is constituted by, for example, a liquid crystal display device corresponding to, for example, a time division parallax image method, a lenticular method and a parallax barrier method. The stereoscopic image display device 23 is driven by the display driver 22.

The touch panel 19 is adhered on a display surface of the stereoscopic image display device 23. The touch panel 19 corresponds to a multi touch, and transmits information according to a touch operation of a user on the touch panel 19 such as, for example, coordinate information of respective contact points of two objects (for example, two fingers of the user) on a screen of the stereoscopic image display device 23, information on presence or absence of movement from the contact points of the two objects, or coordinate information on movement destinations of the two objects, to the system control unit 11.

The memory control unit 15, the digital signal processing unit 17, the compression/expansion processing unit 18, the touch panel 19, the external memory control unit 20 and the display driver 22 are connected to each other by a control bus 24 and a data bus 25, and are controlled by commands from the system control unit 11.

In the digital camera 1, when photographing is performed by the imaging unit 10, stereoscopic image data are generated by the digital signal processing unit 17, and are recorded in the recording medium 21.

When an instruction for playing back the stereoscopic image data recorded in the recording medium 21 is made, the display driver 22 allows a stereoscopic image based on the stereoscopic image data to be displayed on the stereoscopic image display device 23 by a command of the system control unit 11. In the digital camera 1, the stereoscopic image displayed on the stereoscopic image display device 23 may be enlarged by an operation of the touch panel 19. Hereinafter, descriptions will be made on the operation of the digital camera 1 when the stereoscopic image is displayed in an enlarged scale.

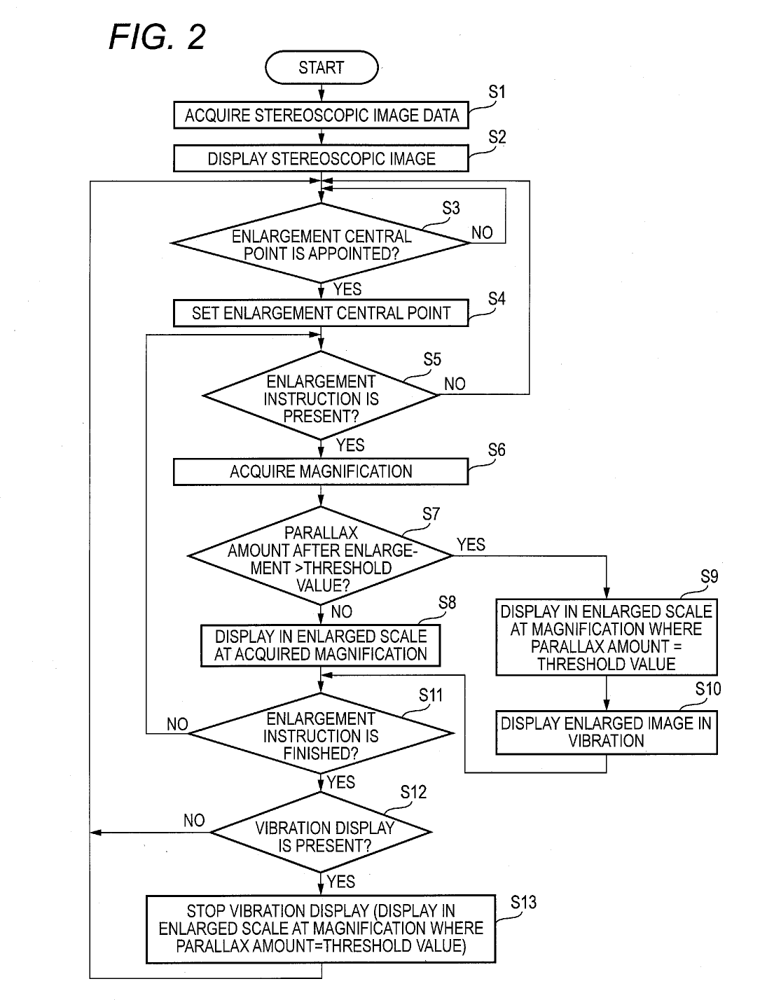

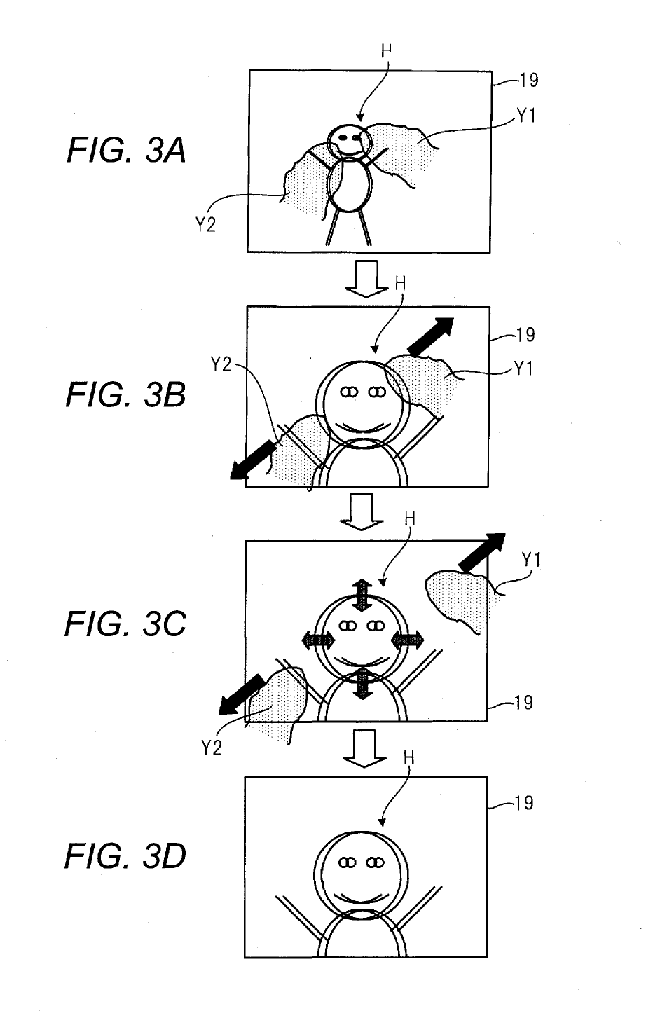

FIG. 2 is a flow chart for explaining an operation of the digital camera 1 illustrated in FIG. 1 during of an enlargement operation of a stereoscopic image. FIGS. 3A to 3D are views illustrating an exemplary screen displayed on the stereoscopic image display device 23 during the operation based on the flow chart illustrated in FIG. 2.

When the digital camera 1 is set to be in a play-back mode, and the instruction of playing back stereoscopic image data. recorded in the recording medium 21 is made by a user, the system control unit 11 reads the stereoscopic image data from the recording medium 21 to expand the stereoscopic image data in the main memory 16 (step S1). The system control unit 11 causes a stereoscopic image based on the expanded stereoscopic image data to be displayed on the stereoscopic image display device 23 through the display driver 22 (step S2).

Here, a screen display of the stereoscopic image display device 23 may be the same as illustrated in FIG. 3A. In the example illustrated in FIG. 3A, a stereoscopic image including a subject H is displayed on the stereoscopic image display device 23. On the exemplary screen illustrated in FIGS. 3A to 3D, two images photographed at different viewpoints are simultaneously displayed on the stereoscopic image display device 23, the two images constituting the stereoscopic image. FIGS. 3A to 3D illustrate the state of the image displayed on the stereoscopic image display device 23, when viewed through the touch panel 19.

In a state where the stereoscopic image is displayed as illustrated in FIG. 3A, a user places a forefinger Y1 and a thumb Y2 on free positions of the touch panel 19. Then, coordinate information on the screen indicating respective contact positions of the forefinger Y1 and the thumb Y2 is transmitted from the touch panel 19 to the system control unit 11.

After step S2, the system control unit 11 determines, based on the information from the touch panel 19, if an enlargement central point (a point indicating the center at enlargement of the stereoscopic image) has been appointed on the stereoscopic image being displayed on the stereoscopic image display device 23 (step S3). Specifically, the system control unit 11 determines that the enlargement central point has been appointed when receiving the coordinate information of the two fingers from the touch panel 19, and determines that the enlargement central point has not been appointed when not receiving the coordinate information of the two fingers from the touch panel 19.

When the determination result in step S3 is YES, the system control unit 11, based on the coordinate information received from the touch panel 19, sets the enlargement central point on the stereoscopic image (step S4). For example, the system control unit 11 sets a middle point of coordinates of the two objects included in the coordinate information, as the enlargement central point.

When the user makes an enlargement instruction by moving the two fingers in a separation direction of the two fingers as illustrated in FIG. 3B from the state illustrated in FIG. 3A, object movement information indicating that the two fingers have been moved, respectively, and coordinate information on movement destinations of the respective two fingers are transmitted to the system control unit 11 from the touch panel 19.

After step S4, the system control unit 11 determines, based on the information from the touch panel 19, if the enlargement instruction has been made on the stereoscopic image being displayed on the stereoscopic image display device 23 (step S5). Specifically, the system control unit 11 determines that the enlargement instruction has been made when receiving the object movement information and the coordinate information on movement destinations, and determines that the enlargement instruction has not been made when not receiving the object movement information and the coordinate information on movement destinations.

When the determination result in step S5 is YES, the system control unit 11 receives the enlargement instruction from the user, and calculates movement amounts of the two fingers from the coordinate information on initial positions of the two fingers received after step S2, and the coordinate information on movement destinations of the two fingers received after step S4 to acquire magnification information of the stereoscopic image according to the movement amounts (step S6). The magnification information corresponding to the movement amounts is stored in the ROM within the main memory 16 in advance, and the system control unit 11 acquires the magnification information corresponding to the movement amounts of the fingers from the ROM. When the determination result in step S5 is NO, the system control unit 11 returns the process back to step S3.

Then, when the stereoscopic image has been enlarged around the enlargement central point set in step S4 at the magnification acquired in step S6, the system control unit 11 obtains a parallax amount of the enlarged stereoscopic image displayed on the stereoscopic image display device 23. The parallax amount of the enlarged stereoscopic image indicates a pixel shift amount (reference numerals Po and Pb exemplified in FIG. 11) in relation to a common subject included in each of two images which constitute the enlarged stereoscopic image. However, an enlarged stereoscopic image may include a plurality of subjects. Thus, in the present exemplary embodiment, a representative value of parallax amounts may be obtained as a parallax amount of the enlarged stereoscopic image.

As a method of calculating a parallax amount of an enlarged stereoscopic image, the following four methods may be exemplified.

1. A parallax amount of a main subject included in the enlarged stereoscopic image (e.g., a subject having the largest size among subjects extracted from the enlarged stereoscopic image, or a subject located at the center of the enlarged stereoscopic image) is set as a parallax amount of the enlarged stereoscopic image.

2. Among parallax amounts of respective subjects included in the enlarged stereoscopic image, the largest parallax amount is set as a parallax amount of the enlarged stereoscopic image.

3. A histogram is made on parallax amounts of respective subjects included in the enlarged stereoscopic image, and a parallax amount which is the most numerous in the histogram (a peak value of the histogram) is set as a parallax amount of the enlarged stereoscopic image.

4. An average value of parallax amounts of respective subjects included in the enlarged stereoscopic image is set as a parallax amount of the enlarged stereoscopic image.

When the enlarged stereoscopic image is the same as that illustrated in FIG. 11, for example, Po or {(Po+Pb)/2} is obtained as a parallax amount of the enlarged stereoscopic image.

Meanwhile, each subject included in the stereoscopic image appears to be present on a tubular surface of the stereoscopic image display device 23 when its parallax amount is 0, and appears to be protruded or retracted from the tubular surface when its parallax amount is increased. When the protrusion side and the retraction side are treated with opposite parallax amount signs (+−), as the largest parallax amount in the calculation method 2 (as described above), for example, a maximum value of absolute values of parallax amounts in subjects at either the protrusion side or the retraction side, or a maximum value of absolute values of parallax amounts in subjects at both sides may be used.

As the average value in the calculation method 4 (as described above), for example, an average value of parallax amounts in subjects at either the protrusion side or the retraction side, or an average value of absolute values of parallax amounts in subjects at both sides may be used.

When obtaining the parallax amount of the enlarged stereoscopic image, the system control unit 11 determines if the obtained parallax amount (as an absolute value irrespective of signs) is greater than a threshold value (step S7).

The threshold value is an upper limit of a parallax amount which may provide a stereoscopic effect to some extent which does not cause a burden on eyes of the user who observes the enlarged stereoscopic image. The threshold value is recorded in advance in the ROM within the main memory 16.

When the determination in step S7 is NO, that is, when the parallax amount of the stereoscopic image after the enlargement is not greater than the threshold value, the system control unit 11 causes the stereoscopic image to be displayed on the stereoscopic image display device 23 in an enlarged scale at the magnification acquired in step S6 (step S8). The state herein is illustrated in FIG. 3B.

When the determination in step S7 is YES, that is, when the parallax amount of the stereoscopic image after the enlargement is greater than the threshold value, the system control unit 11 does not enlarge the stereoscopic image at the magnification acquired in step S6 (stops an enlargement processing according to the enlargement instruction), and causes the enlarged stereoscopic image (in an enlarged scale at the magnification at which parallax amount=threshold value) being displayed on the stereoscopic image display device 23 to be continuously displayed (step S9). Simultaneously with or immediately after step S9, the system control unit 11 performs a control of causing the enlarged stereoscopic image (in an enlarged scale at the magnification at which parallax amount=threshold value) to be displayed in vibration within the screen (step S10). In the control, specifically, the enlarged stereoscopic image is moved in a parallel manner in a direction parallel to the display screen around a region on which the enlarged stereoscopic image is displayed, while the movement amount or movement direction is changed with time. The enlarged stereoscopic image displayed on the stereoscopic image display device 23 through the processing in step S10 is displayed in vibration upward and downward, leftward and rightward, or both within the screen as illustrated in FIG. 3C.

Meanwhile, in step S10, the enlarged stereoscopic image may not be vibrated within the screen, but a reduced image and an enlarged image of the enlarged stereoscopic image may be displayed to be alternately repeated. Meanwhile, here, a reduction rate and a magnification of the enlarged stereoscopic image are set as small values which do not impair the stereoscopic effect of the enlarged stereoscopic image at the magnification at which parallax amount=threshold value.

The processing in step S10 is performed to allow the user recognize that the enlargement display processing according to the enlargement instruction is not being performed in consideration of a burden to eyes of the user because the parallax amount of the enlarged stereoscopic image displayed on the stereoscopic image display device 23 is greater than the threshold value. In the above described example, it is assumed that the user recognizes the processing being performed by the digital camera 1 through a change in the display of the enlarged stereoscopic image itself. Further, text information such as, for example, “an enlargement display processing is stopped due to an extremely large parallax” may be displayed together with the enlarged stereoscopic image on the stereoscopic image display device 23 so that the user may recognize the processing being performed by the digital camera 1.

Meanwhile, the threshold value may be varied depending on preferences or ages of the user. For example, a plurality of types of threshold values may be recorded in the main memory 16 of the digital camera 1. Then, the system control unit 11 may cause any one of the plurality of types of threshold values to be selected and used according to the user of the digital camera 1.

More specifically, a plurality of types of threshold values may be recorded in the main memory 16 according to age ranges of the user (e.g., three of age ranges such as infants younger than elementary school students, elementary and middle school students, high school students or older). Through the operation unit 14 or the touch panel 19 of the digital camera 1, information on the user (e.g., age information) may be input. The system control unit 11 acquires the input information on the user, and sets, based on the user age information included in the information on the user, a type of threshold value corresponding to an age range including the age of the user, as the threshold value to be used in the determination in step S7.

Otherwise, among the plurality of types of threshold values recorded in advance, a threshold value according to a preference of the user may be selected and registered to correspond to the user information. In this case, the user selects his/her own information from user information registered in advance before playing back the stereoscopic image. When the user information is selected, the system control unit 11 acquires the user information, and sets a threshold value corresponding to the user information as the threshold value to be used in determination in step S7.

In this manner, a plurality of types of threshold values may be recorded, and a threshold value according to the user may be used in determination in step S7 so that a control according to the age or preference of the user may be possible.

After step S8 and step S10, the system control unit 11 determines if the enlargement instruction is finished (step S11). The system control unit 11 determines that the enlargement instruction is finished when receiving information indicating that a contact of at least one of the two objects has disappeared from the touch panel 19.

When the enlargement instruction is not finished (step S11: NO), the processing in step S5 is performed. When the enlargement instruction is finished (step S11: YES), the system control unit 11 determines if the processing in step S10 is being performed (step S12).

When the determination in step S12 is YES, the system control unit 11 stops the vibration display processing, the reduction/enlargement alternate display processing, or the text information display processing of the enlarged stereoscopic image in an enlarged scale at the magnification at which parallax amount=threshold value, and causes the enlarged stereoscopic image in an enlarged scale at the magnification at which parallax amount=threshold value to be displayed on the stereoscopic image display device 23 (step S13). The state herein is illustrated in FIG. 3D. At a point of time when the finger is released from the touch panel 19 in the state of FIG. 3C the change in the display of the enlarged displayed image (vibration and reduction/enlargement of the image) is stopped, and the enlarged stereoscopic image in an enlarged scale at the magnification at which parallax amount=threshold value is displayed on the stereoscopic image display device 23.

The system control unit 11 returns the process back to step S3 after step S13.

As described above, in the digital camera 1, When the two fingers come in contact with the touch panel 19 and are moved in a separation direction of the two fingers, the stereoscopic image is displayed to be gradually enlarged according to the movement of the two fingers until a magnification at which the parallax amount equals the threshold value. Then, at the magnification at which the parallax amount equals the threshold value, enlargement of the displayed image is not performed even though a further enlargement instruction is made. Accordingly, it is possible to suppress an enlarged stereoscopic image with a strong stereoscopic effect from being observed by the user, thereby reducing a burden on eyes of the user.

When the enlargement instruction is made beyond the magnification at which the parallax amount equals the threshold value, as illustrated in FIG. 3C, the enlarged stereoscopic image is displayed on the stereoscopic image display device 23 in a different display form from that of the stereoscopic image enlarged at a magnification at which the parallax amount is not greater than the threshold value. Accordingly, through the change of the display form of the enlarged stereoscopic image, the user may recognize that the digital camera 1 is performing a certain special processing. Accordingly, by the special processing, the user may be suppressed from misunderstanding that the stereoscopic image is not enlarged due to his/her mistake in an enlargement operation.

In the above description, in steps S9 and S13 of FIG. 2, the stereoscopic image to be displayed on the stereoscopic image display device 23 is enlarged at the magnification at which parallax amount threshold value. However, in steps S9 and S13, the enlarged stereoscopic image to be displayed may be enlarged at the magnification at which parallax amount<threshold value. However, the magnification of the enlarged stereoscopic image displayed in steps S9 and S13 is too small, the displayed image is suddenly changed in the vicinity of a boundary where the parallax amount is greater than the threshold value. Thus, it is desirable that the magnification is set as a value which does not cause the user to recognize the sudden change of the displayed image.

In step S10, when the enlarged stereoscopic image is displayed in vibration, the vibration direction of the enlarged stereoscopic image may substantially match the separation direction of the fingers of the user.

For example, the system control unit 11 determines the movement direction of two objects (fingers) within the screen from initial position information of the two objects, and position information on movement destinations of the two objects in relation to initial positions, the information being received from the touch panel 19. The system control unit 11 performs, in step S10, a control of causing the enlarged stereoscopic image to be vibrated in the determined movement direction. In this manner, the enlarged stereoscopic image is vibrated in the separation direction of the fingers of the user. Thus, it is possible to achieve a good operability without a sense of discomfort unlike a case where a vibration direction of the enlarged stereoscopic image does not match the separation direction of the fingers of the user (for example, two directions are perpendicular to each other).

Hereinafter, a modified example of the operation of the digital camera 1 will be described. In the modified example, even when an enlargement instruction for enlarging a stereoscopic image beyond a magnification at which the parallax amount equals the threshold value is made, the system control unit 11 causes an enlarged stereoscopic image in an enlarged scale at the magnification according to the enlargement instruction to be displayed on the stereoscopic image display device 23 at least during the enlargement instruction. The system control unit 11 causes the enlarged stereoscopic image in an enlarged scale at a magnification at which the parallax amount is not greater than the threshold value to be displayed on the stereoscopic image display device 23, when the enlargement instruction is finished.

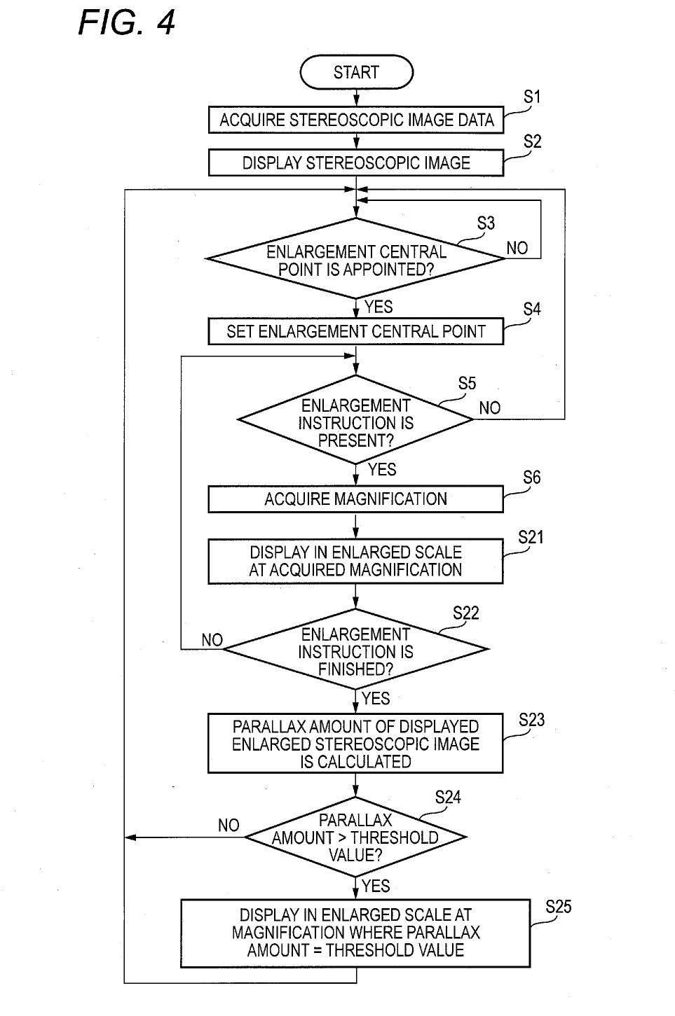

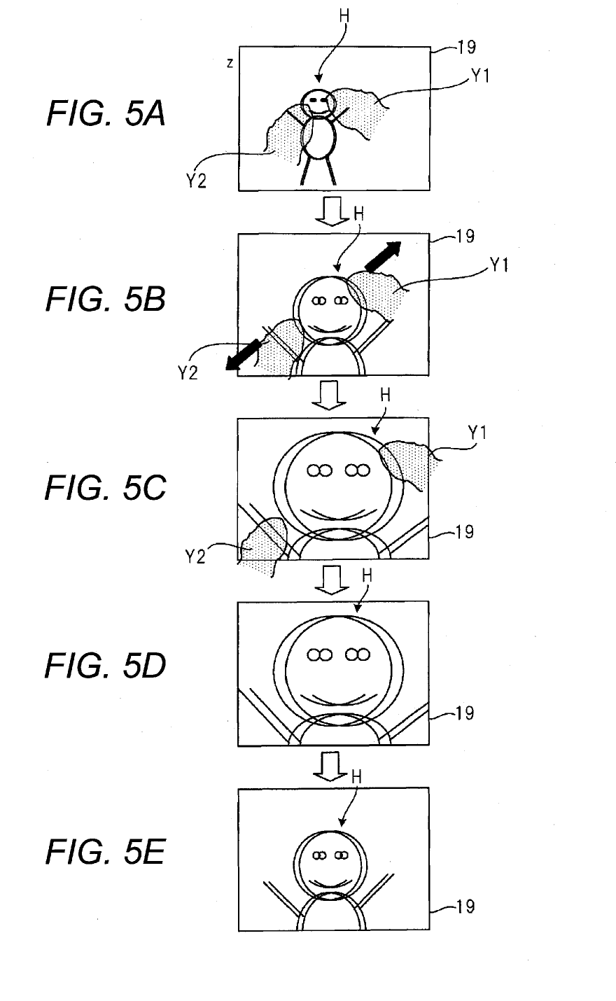

FIG. 4 is a flow chart for explaining the modified example of an operation of the digital camera 1 illustrated in FIG. 1 during an enlargement operation of a stereoscopic image. FIGS. 5A to 5E are views illustrating an exemplary screen displayed on the stereoscopic image display device 23 during the operation based on the flow chart of the modified example illustrated in FIG. 4.

In the flow chart illustrated in FIG. 4, processings subsequent to step S6 in the flow chart illustrated in FIG, 2 are substituted by steps S21 to S25. Thus, the same processings as those illustrated in FIG. 2 are given the same reference numerals and descriptions thereof will be omitted.

When a user makes an enlargement instruction by bringing a forefinger Y1 and a thumb Y2 in contact with the touch panel 19 as illustrated in FIG, 5A, and moving the forefinger Y1 and the thumb Y2, respectively, as illustrated in FIG. 5B, information of magnification is acquired by the system control unit 11 in step S6 of FIG. 4. Then, the system control unit 11 causes the enlarged stereoscopic image in an enlarged scale at the acquired magnification to be displayed on the stereoscopic image display device 23 (step S21).

The system control unit 11 determines if the enlargement instruction is finished in the same manner as in step S11 of FIG. 2 (step S22). When the enlargement instruction is not finished, the system control unit 11 returns the process back to step S5, and when the enlargement instruction is finished, the system control unit 11 causes the processing in step S23 to be performed.

In step S23, the system control unit 11 obtains a parallax amount of the enlarged stereoscopic image being displayed on the stereoscopic image display device 23. The system control unit 11 determines if the parallax amount obtained in step S23 is greater than the threshold value (step S24).

When the determination in step S24 is NO, the system control unit 11 returns the process back to step S3. When the determination in step S24 is YES, the system control unit 11 causes the enlarged stereoscopic image in an enlarged scale at the magnification at which parallax amount=threshold value to be displayed on the stereoscopic image display device 23 (step S25).

For example, when the user finishes the enlargement instruction by releasing fingers from the touch panel 19 as illustrated in FIG. 5D after the stereoscopic image is displayed in an enlarged scale at the magnification at which the parallax amount is greater than the threshold value as illustrated in FIG. 5C, the system control unit 11 performs a control of switching the enlarged stereoscopic image being displayed on the stereoscopic image display device 23 as illustrated in FIG. 5D just before the enlargement instruction is finished, to the enlarged stereoscopic image in an enlarged scale at the magnification at which parallax amount=threshold value, as illustrated in FIG. 5E.

After step S25, the system control unit 11 returns the process back to step S3.

As described above, in the modified example, when the two fingers come in contact with the touch panel 19 and are moved in a separation direction of the two fingers, the stereoscopic image is continuously enlarged as illustrated in FIGS. 5B and 5C even beyond the magnification at which the parallax amount equals the threshold value. When the enlargement instruction is finished in the state of FIG. 5C, the enlarged stereoscopic image in an enlarged scale at the magnification at which parallax amount=threshold value is displayed on the stereoscopic image display device 23 as illustrated in FIG. 5E. Accordingly, after the enlargement instruction is finished, it is possible to suppress an enlarged stereoscopic image with a strong stereoscopic effect from being observed by the user, thereby reducing a burden on eves of the user.

Meanwhile, when, in step S25 of FIG. 4, the enlarged stereoscopic image to be displayed on the stereoscopic image display device 23 is switched from an enlarged stereoscopic image in an enlarged scale at a magnification to (A times) at which the parallax amount is greater than the threshold value, to an enlarged stereoscopic image in an enlarged scale at a magnification (B times) at which the parallax amount equals the threshold value, the system control unit 11 may gradually decrease the magnification from A times to B times (gradually change the magnification at a predetermined change rate) so that enlarged stereoscopic images at respective magnifications during the decrease of the magnification may be displayed on the stereoscopic image display device 23. In this manner, the image is not suddenly switched from the state of FIG. 5D to the state of FIG. 5E, but may be smoothly switched, thereby reducing a burden on eyes of the user.

After or simultaneously with step S25 of FIG. 4 in which the enlarged stereoscopic image in an enlarged scale at the magnification at which the parallax amount equals the threshold value is displayed, information such as, for example, “an image at a decreased magnification is being displayed because the parallax becomes extremely large at the instructed magnification” which notifies the processing contents of the digital camera 1 may be displayed on the stereoscopic image display device 23. In this manner, the user may be suppressed from misunderstanding that the stereoscopic image is not enlarged due to his/her mistake in an enlargement operation.

Meanwhile, in the flow chart of FIG. 4, the enlarged stereoscopic image displayed on the stereoscopic image display device 23 in step S25 is enlarged at the magnification at which parallax amount=threshold value. However, in step S25, the stereoscopic image in an enlarged scale at a magnification at which the parallax amount is less than the threshold value may be displayed.

When an enlargement central point has been appointed in step S3 of FIG. 2 and FIG. 4, the system control unit 11 of the digital camera 1 may cause a frame image indicating a movement range of fingers to be displayed on the stereoscopic image display device 23, the movement range allowing the parallax amount of the stereoscopic image displayed on the stereoscopic image display device 23 to be the threshold value or less.

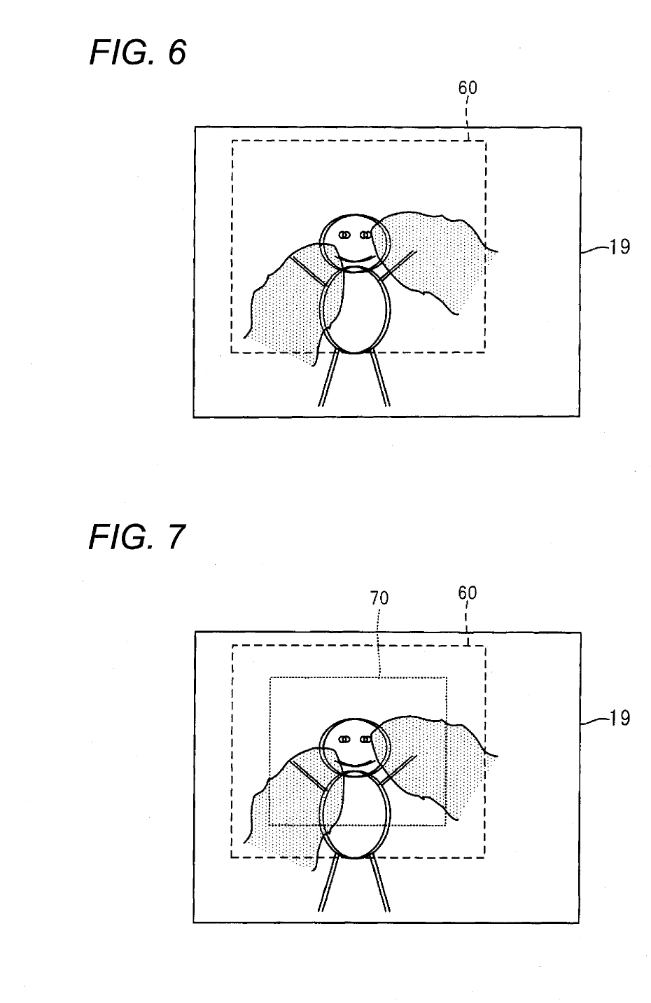

When two fingers of the user come in contact with the touch panel 19, the system control unit 11 calculates an allowable magnification at which the parallax amount equals threshold value, from the parallax amount of the stereoscopic image being displayed. The system control unit 11 obtains positions to which the two fingers are moved at the allowable magnification from contact position information of the two fingers, and data of a table (recorded in the main memory 16) in which a movement distance of each of the two fingers in contact with the touch panel 19 is associated with a magnification of the stereoscopic image, so as to generate a frame image 60 which includes connected coordinates indicating positions to which the two fingers are moved. The system control unit 11, as illustrated in FIG. 6, causes the frame image 60 to be displayed on the stereoscopic image display device 23.

The frame image 60 may become information that indicates the parallax amount of the stereoscopic image displayed in an enlarged scale on the stereoscopic image display device 23 is not greater than the threshold value when the positions to which the fingers are moved are within the frame, and the parallax amount of the stereoscopic image displayed in an enlarged scale on the stereoscopic image display device 23 is greater than the threshold value when the positions to which the fingers are moved are out of the frame. Since the movement amount of each of fingers corresponds to the magnification, it can be said that the frame image 60 is information that indicates an allowable magnification allowing the parallax amount to be the threshold value or less. At a point of time when the enlargement central point of the stereoscopic image is appointed, the system control unit 11 causes the frame image 60 to be displayed on the stereoscopic image display device 23, the frame image 60 indicating the movement range of the fingers in which the parallax amount of the stereoscopic image after enlargement is not greater than the threshold value. In this manner, the user may know an extent of an enlargement operation which allows a good stereoscopic effect to be obtained, thereby improving usability.

The system control unit 11, besides the frame image 60, may cause a frame image 70 to be displayed as illustrated in FIG. 7. The frame image 70 indicates movement positions of fingers at which the parallax amount of the stereoscopic image to be displayed in an enlarged scale on the stereoscopic image display device 23 has the most suitable value for stereoscopic vision.

The parallax amount which is the most suitable for stereoscopic vision may be a conventionally known value which has been empirically obtained, or an average value of the parallax amount and the threshold value of the stereoscopic image displayed on the stereoscopic image display device 23. For example, parallax amounts as described in http://www.3dc.gr.jp/jp/scmt_wg_rep/3dc_guideJ_{—}20100420.pdf may be employed.

The system control unit 11 calculates an optimum magnification from the parallax amount of the stereoscopic image being displayed on the stereoscopic image display device 23. The optimum magnification allows the parallax amount to be an optimum value. The system control unit 11 obtains positions to which the two fingers are moved at the optimum magnification from contact position information of the two fingers, and data of the above described table so as to generate the frame image 70 which includes connected coordinates indicating positions to which the two fingers are moved. Then, the system control unit 11, as illustrated in FIG. 7, causes the frame image 70 to be displayed on the stereoscopic image display device 23.

The frame image 70 may become information that indicates the parallax amount of the stereoscopic image displayed in an enlarged scale on the stereoscopic image display device 23 is an optimum value when the positions to which the fingers are moved are on the frame. Since the movement amount of each of fingers corresponds to the magnification, it can be said that the frame image 70 is information that indicates an optimum magnification allowing the parallax amount to be the optimum value. In this manner, at a point of time when the enlargement central point of the stereoscopic image is appointed, the system control unit 11 may cause the frame image 70 to be displayed on the stereoscopic image display device 23, the frame image 70 indicating the movement positions of the fingers at which the parallax amount of the stereoscopic image after enlargement has an optimum value. Thus, the user may know an extent of an enlargement which allows an optimum stereoscopic effect to be obtained, thereby improving usability.

Meanwhile, in the example illustrated in FIG. 7, both the frame image 60 and the frame image 70 are displayed, but only the frame image 70 may be displayed.

The display range of the stereoscopic image displayed on the stereoscopic image display device 23 becomes narrower according to the enlargement instruction. Accordingly, in a case of a stereoscopic image which includes a subject having a peripheral portion with a large parallax amount, and a central portion with a small parallax amount, when the stereoscopic image is gradually enlarged, the parallax amount of the stereoscopic image after the enlargement in an enlarged scale displayed on the stereoscopic image display device 23 is also gradually increased. Then, beyond a certain extent of a magnification, the range displayed on the stereoscopic image display device 23 may be narrowed to only the central portion of the subject, and the parallax amount may be suddenly the threshold value or less.

Hereinafter, descriptions will be made on a case where the user makes a forced operation (for example, the user continuously places fingers on the touch panel 19, or increases the moving speed of the fingers) in the state of FIG. 5C (in which the parallax amount initially exceeds the threshold value) in the modified example illustrated in FIG. 4 and FIGS. 5A to 5E. In this case, the system control unit 11 causes the enlarged stereoscopic image in an enlarged scale at a magnification which is greater than a magnification allowing the parallax amount to equal the threshold value but allows the parallax amount to be the threshold value or less to be displayed on the stereoscopic image display device 23, instead of the enlarged stereoscopic image as illustrated in FIG. 5E. Through such a control, an enlarged stereoscopic image having a large parallax amount is suppressed from being displayed on the stereoscopic image display device 23 for a long time, thereby reducing a burden on eyes of the user.

Meanwhile, in the above described exemplary embodiments, the touch panel 19 is used as an interface for an enlargement instruction. However, the interface is not limited to this. For example, the enlargement instruction of a stereoscopic image may be performed by, for example, cross keys, dial keys, or various buttons included in the operation unit 14. When the enlargement instruction is performed by using the operation unit 14, an allowable magnification may be displayed by text information instead of the frame image 60 illustrated in FIG. 6. Further, an optimum magnification may be displayed by text information instead of the frame image 70 illustrated in FIG. 7.

In the above described exemplary embodiments, a digital camera is exemplified, but the technology described in the present exemplary embodiments may be employed in any electronic device (e.g., a television for 3D display, a smart phone, a tablet PC) mounted with a stereoscopic image display control device configured to control a stereoscopic image to be displayed on a stereoscopic image display device based on stereoscopic image data. In such an electronic device, a CPU (computer) mounted in the electronic device performs respective steps of the flow chart illustrated in FIG. 2 or FIG. 4 so as to reduce a burden on a user who observes the stereoscopic image display device.

The digital camera 1 illustrated in FIG. 1 includes the stereoscopic image display device 23 mounted therein as a display destination of, for example, a stereoscopic image, but the display destination may be, for example, an external stereoscopic image display device (e.g., a television for 3D display) connected to the digital camera 1.

The above described threshold value may be varied according to a screen size of a display device on which a stereoscopic image is displayed, or a distance (a viewing distance) from the display device to a user.

For example, the system control unit 11 may perform a control of decreasing the threshold value as the screen size is increased, or decreasing the threshold value as the viewing distance is decreased. Information on the screen size may be acquired from the display device by the system control unit 11, or may be input by the user. As viewing distance information, a predetermined optimum value for each display device may be used. Otherwise, a distance measuring unit configured to measure distance from the user may be provided at the display device side.

Hereinafter, a configuration of a smart phone as an electronic device mounted with the stereoscopic image display control device will be described.

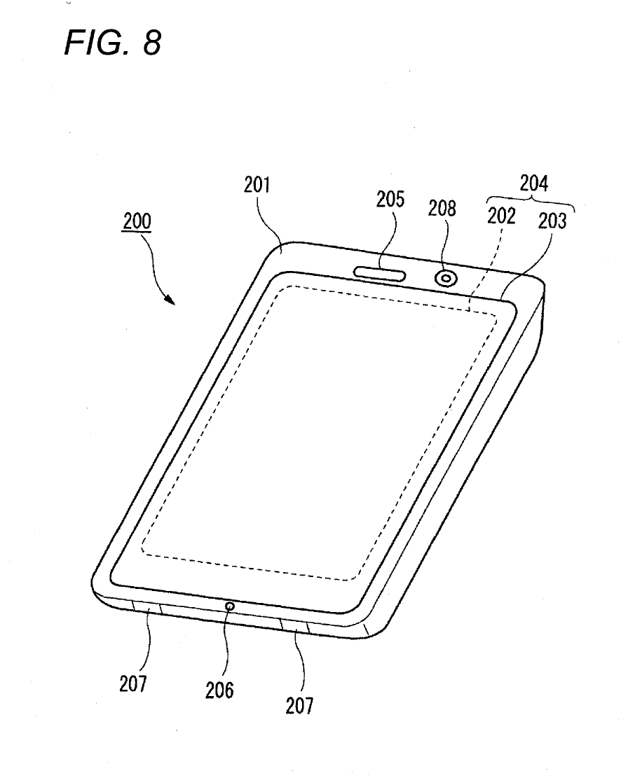

FIG. 8 is a view illustrating an external appearance of a smart phone 200 as an exemplary photographing apparatus of the present invention. The smart phone 200 illustrated in FIG. 8 includes a plate-shaped housing 201, and a display input unit 204 on one-side surface of the housing 201. The display input unit 204 includes a display panel 202 as a display unit, and an operation panel 203 as an input unit, which are integrated with each other. The housing 201 includes a speaker 205, a microphone 206, an operation unit 207, and a camera unit 208. Meanwhile, the configuration of the housing 201 is not limited to this. For example, it is possible to employ other configurations in which a display unit and an input unit are separate, or a folding structure or a sliding mechanism is included.

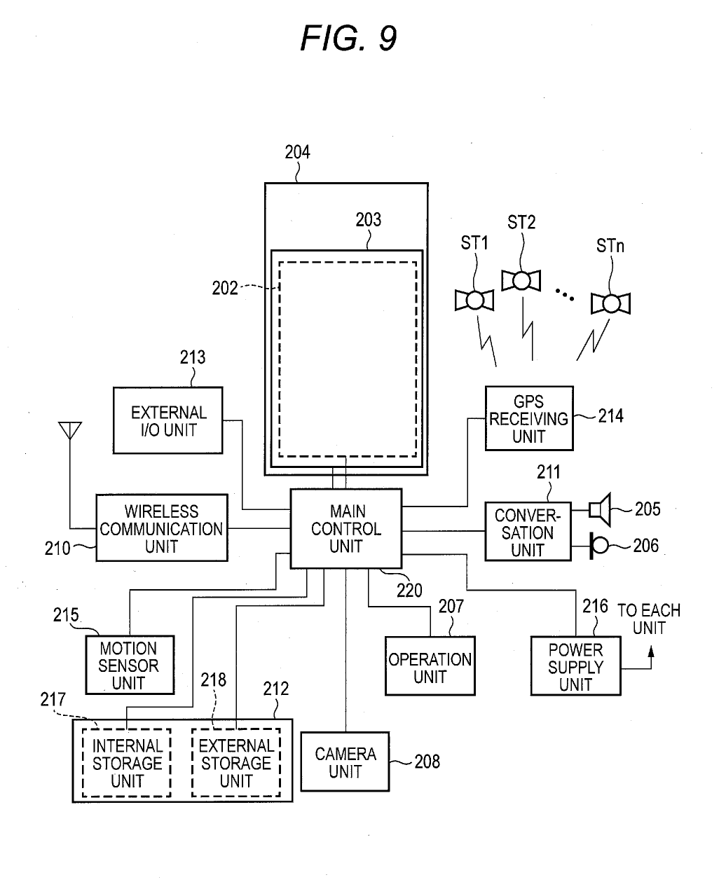

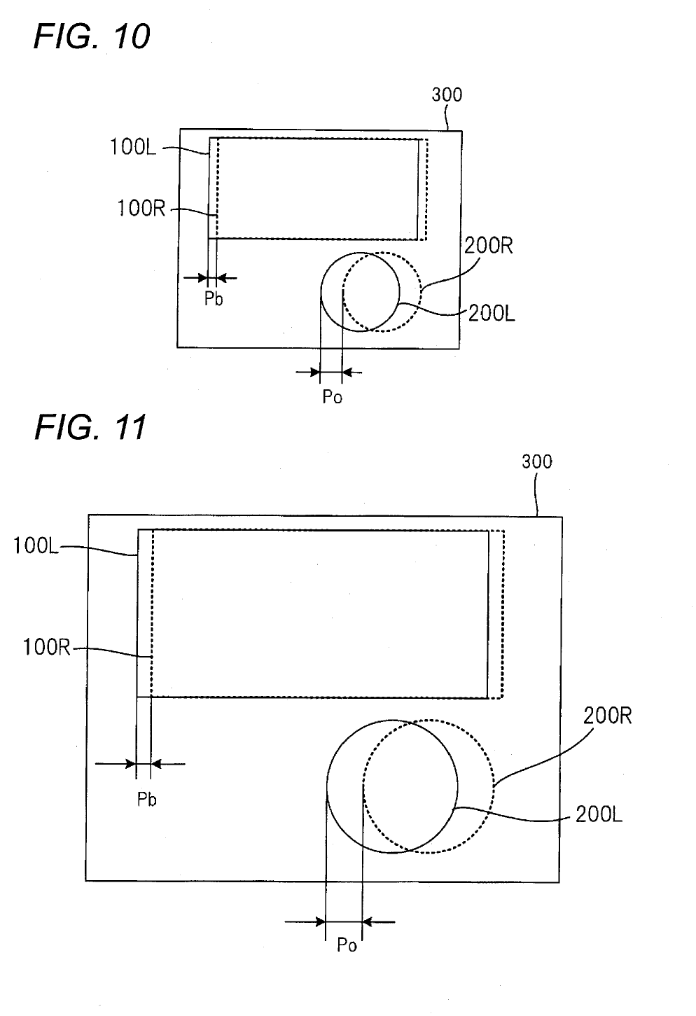

FIG. 9 is a block diagram illustrating the configuration of the smart phone 200 illustrated in FIG. 8. As illustrated in FIG. 9, main elements of the smart phone include a wireless communication unit 210, the display input unit 204, a conversation unit 211, the operation unit 207, the camera unit 208, a storage unit 212, an external I/O unit 213, a GPS (Global Positioning System) receiving unit 214, a motion sensor unit 215, a power supply unit 216, and a main control unit 220. The smart phone 200 has, as a main function, a wireless communication function in which a mobile radio communication is performed through a base station device BS (not illustrated) and a mobile communication network NW (not illustrated).

The wireless communication unit 210 performs a radio communication in relation to the base station device BS accommodated in the mobile communication network NW under the instruction of the main control unit 220. By using the radio communication, reception and transmission of various file data such as audio data or image data, and e-mail data, and reception of web data or streaming data are performed.

The display input unit 204 is a so-called touch panel which displays, for example, an image (a still image or a moving image) or text information to visually provide information to a user, and at the same time, detects user information on the displayed information under the control of the main control unit 220. The display input unit 204 includes the display panel 202 and the operation panel 203.

The display panel 202 uses, for example, a liquid crystal display (LCD), or an organic electro-luminescence display (OELD) as a display device.

The operation panel 203 is a device which is mounted so that an image displayed on a display surface of the display panel 202 is recognizable, and detects one or more coordinates operated by a finger of a user or a stylus. When the device is operated by the finger of the user or the stylus, a detection signal generated due to the operation is output to the main control unit 220. Then, the main control unit 220 detects an operation location (a coordinate) on the display panel 202 based on the received detection signal.

As illustrated in FIG. 8, in the smart phone 200 as an exemplary photographing apparatus of the present invention, the display panel 202 and the operation panel 203 are integrated to constitute the display input unit 204, in which the operation panel 203 is disposed to completely cover the display panel 202.

When such a disposition is employed, the operation panel 203 may serve to detect a user operation even in a region outside the display panel 202. That is, the operation panel 203 may have one region for detecting a. portion overlapping the display panel 202 (hereinafter, referred to as a display region), and the other region for detecting a periphery portion not overlapping the display panel 202 (hereinafter, referred to as a non-display region).

Meanwhile, the size of the display region and the size of the display panel 202 may completely match each other, but do not have to necessarily match each other. The operation panel 203 may have two sensitive regions including an outer region and an inner region. The width of the outer region is properly designed according to, for example, the size of the housing 201. As a location detecting method, for example, a matrix switch method, a resistance film method, a surface acoustic wave method, an infrared method, an electromagnetic induction method, or an electrostatic capacitance method may be employed in the operation panel 203, or other methods may be employed.

The conversation unit 211 includes the speaker 205 or the microphone 206. The conversation unit 211 converts a user voice input through the microphone 206 into audio data processible in the main control unit 220 and outputs the audio data to the main control unit 220, or decodes the audio data received by the wireless communication unit 210 or the external I/O unit 213, and outputs the decoded audio data from the speaker 205. As illustrated in FIG. 8, for example, the speaker 205 may be mounted at the same plane as the surface where the display input unit 204 is provided, and the microphone 206 may be mounted at the side surface of the housing 201.

The operation unit 207 is a hardware key using, for example, a key switch, and receives an instruction from a user. For example, as illustrated in FIG. 8, the operation unit 207 is a push button-type switch mounted at the side surface of the housing 201 of the smart phone 200, which is turned on by being pressed by, for example, a finger, and is turned off by a restoring force of, for example, a spring when the finger is released.

The storage unit 212 stores a control program or control data of the main control unit 220, application software, address data corresponds to a name or a phone number of a communication partner, data of sent and received e-mail, web data downloaded through web browsing, or downloaded contents data, and temporarily stores, for example, streaming data. The storage unit 212 is constituted by an internal storage unit 217 embedded within a smart phone, and an external storage unit 218 having a detachable external memory slot. Meanwhile, each of the internal storage unit 217 and the external storage unit 218 which constitute the storage unit 212 is implemented using a storage medium such as, a flash memory type memory, a hard disk type memory, a multimedia card micro type memory, a card type memory (e.g., a micro SD (registered trademark) memory), a RAM (Random Access Memory), and a ROM (Read Only Memory).

The external I/O unit 213 serves as an interface with all external devices connected to the smart phone 200, and is configured to directly or indirectly connect to other external devices through, for example, a communication (e.g., universal serial bus (USB), or IEEE1394) or a network (e.g., internet, wireless LAN, Bluetooth (registered trademark), Radio Frequency Identification (RFID), Infrared Data Association (IrDA) (registered trademark), Ultra Wide band (UWB) (registered trademark), ZigBee (registered trademark)).

Examples of the external devices connected to the smart phone 200 may include a wired/wireless headset, a wired/wireless external charger, a wired/wireless data port, a memory card or a SIM (Subscriber Identity Module Card)/UIM (User Identity Module Card) card connected through a card socket, an external audio/video device connected through an audio/video I/O (Input/Output) terminal, a wirelessly connected external audio/video device, a wired/wirelessly connected smart phone, a wired/wirelessly connected PC, a wired/wirelessly connected PDA, and an earphone. The external I/O unit 213 may allow data transmitted from these external devices to be transmitted to each component within the smart phone 200, or data within the smart phone 200 to be transmitted to the external devices.

The GPS receiving unit 214, under an instruction of the main control unit 220, receives GPS signals transmitted from GPS satellites ST1 to STn, and executes a positioning calculation process based on the plurality of received GPS signals to detect a location of the smart phone 200 which is constituted by a latitude, a longitude, and an altitude. The GPS receiving unit 214 may detect a location using position information when the position information can be acquired from the wireless communication unit 210 or the external I/O unit 213 (e.g., a wireless LAN).

The motion sensor unit 215 includes, for example, a three-axis acceleration sensor, and detects a physical movement of the smart phone 200 under an instruction of the main control unit 220. When the physical movement of the smart phone 200 is detected, a direction or an acceleration of movement of the smart phone 200 is detected. This detection result is output to the main control unit 220.

The power supply unit 216, under an instruction of the main control unit 220, supplies power accumulated in a battery (not illustrated) to each unit of the smart phone 200.

The main control unit 220 includes a microprocessor and operates according to a control program or control data stored in the storage unit 212 to generally control respective units of the smart phone 200. The main control unit 220 has, for example, a mobile communication control function for controlling respective units of a communication system in order to perform voice communication or data communication through the wireless communication unit 210, and an application processing function.

The application processing function is implemented when the main control unit 220 is operated according to application software stored in the storage unit 212. Examples of the application processing function may include an infrared communication function for performing data communication with the opposing device by controlling the external I/O unit 213, an e-mail function for transmitting and receiving e-mails, and a web browsing function for reading web pages.

The main control unit 220 also includes an image processing function such as displaying of a video on the display input unit 204, based on image data of, for example, received data or downloaded streaming data (data of a still image or a moving image). The image processing function refers to a function performed by the main control unit 220 in which the image data are decoded, and the decoded result is subjected to image processing to display an image on the display input unit 204.

Further, the main control unit 220 executes a display control on the display panel 202, and an operation detection control for detecting a user operation through the operation unit 207 and the operation panel 203. When the display control is executed, the main control unit 220 displays an icon for starting application software, or a software key such as, for example, a scroll bar, or displays a window to write, for example, an e-mail. Meanwhile, the scroll bar refers to a software key configured to receive an instruction for moving a display portion of an image in a case, for example, a large image which, as a whole, cannot be included in the display region of the display panel 202.

When the operation detection control is executed, the main control unit 220 detects the user operation through the operation unit 207, receives an operation on the icon, or input of a character string into an input section of the window through the operation panel 203, or receives a scrolling requirement of a displayed image through the scroll bar.

Also, the main control unit 220 has a touch panel control function so that when the operation detection control is executed, the main control unit 220 determines if an operation location on the operation panel 203 is a portion overlapping the display panel 202 (a display region), or a periphery portion not overlapping the display panel 202 (a non-display region), and controls sensitive regions of the operation panel 203 or a display location of the software key.

The main control unit 220 may detect a gesture operation on the operation panel 203, and execute a predetermined function on the detected gesture operation. The gesture operation does not refer to a conventional simple touch operation, but to an operation of drawing a trail by, for example, a finger, simultaneously specifying a plurality of locations, or drawing a trail for at least one from a plurality of locations by combining these two operations.

The camera unit 208 has the same function as the imaging unit 10. The camera unit 208 is a digital camera which electronically photographs an image by using an imaging device such as a CMOS (Complementary Metal Oxide Semiconductor) or a CCD (Charge-Coupled Device). The camera unit 208, under the control of the main control unit 220, may convert image data obtained by photographing into image data compressed in, for example, JPEG (Joint Photographic coding Experts Group) so as to store the compressed image data in the storage unit 212, or output the compressed image data through the external I/O unit 213 or the wireless communication unit 210. As illustrated in FIG. 8, in the smart phone 200, the camera unit 208 is mounted at the same plane as the surface where the display input unit 204 is provided, but the location where the camera unit 208 is mounted is not limited thereto. The camera unit 208 may be mounted at the rear surface of the display input unit 204.

The camera unit 208 may be used for various functions of the smart phone 200. For example, the image obtained by the camera unit 208 may be displayed on the display panel 202, or the image of the camera unit 208 may be used as one operation input for the operation panel 203. When the GPS receiving unit 214 detects a location, the location may be detected by referring to the image from the camera unit 208. Further, while referring to the image from the camera unit 208, determination on the optical axis direction of the camera unit 208 of the smart phone 200, or a current usage environment may be performed without using the three-axis acceleration sensor, or in conjunction with the three-axis acceleration sensor. Of course, the image from the camera unit 208 may be used within the application software.

Further, the image data of the still image or the moving image may be added with, for example, position information acquired by the GPS receiving unit 214, audio information acquired by the microphone 206 (which may be converted into text information through voice-to-text conversion by, for example, the main control unit), posture information acquired by the motion sensor unit 215 so as to store the obtained image data in the storage unit 212, or output the obtained image data through the external I/O unit 213 or the wireless communication unit 210.

In the smart phone 200 as configured as described above, the main control unit 220 may perform the processing illustrated in FIGS. 2 and 4, the processing being the same as that of the system control unit 11 of the digital camera 1 illustrated in FIG. 1. Thus it is possible to reduce a burden on an observer when a stereoscopic image is enlarged.

As described above, following matters are disclosed in the present specification.

It is disclosed a stereoscopic image display control device which causes a stereoscopic image based on a plurality of image data photographed at different viewpoints to be displayed on a stereoscopic image display device, including: an enlargement instruction receiving unit that receives an enlargement instruction for enlarging the stereoscopic image displayed on the stereoscopic image display device; an enlargement display control unit that causes the stereoscopic image to be displayed in an enlarged scale according to the enlargement instruction on the stereoscopic image display device; and a parallax amount determination unit that determines, when the stereoscopic image is enlarged at a magnification according to the enlargement instruction, whether or not a parallax amount of the enlarged stereoscopic image displayed on the stereoscopic image display device is greater than a threshold value, in which when the enlargement instruction for enlarging the stereoscopic image at the magnification at which the parallax amount is greater than the threshold value is made, the enlargement display control unit causes the enlarged stereoscopic image to be displayed on the stereoscopic image display device after the enlargement instruction is finished to become the enlarged stereoscopic image in the enlarged scale at the magnification at which the parallax amount is not greater than the threshold value.

In the disclosed stereoscopic image display control device, during an enlargement instruction period in which the enlargement instruction for enlarging the stereoscopic image beyond the magnification at which the parallax amount equals the threshold value is being made, the enlargement display control unit stops enlargement processing according to the enlargement instruction, and causes the enlarged stereoscopic image in the enlarged scale at the magnification at which the parallax amount equals the threshold value to be displayed on the stereoscopic image display device in a display form different from a form of the stereoscopic image in the enlarged scale at the magnification at which the parallax amount is not greater than the threshold value.

In the disclosed stereoscopic image display control device, the enlargement display control unit, during the enlargement instruction period, causes the enlarged stereoscopic image in the enlarged scale at the magnification at which the parallax amount equals the threshold value to be displayed in vibration within a screen of the stereoscopic image display device, or causes to be displayed in an enlarged scale and a reduced scale alternately and repeatedly.

In the disclosed stereoscopic image display control device, the stereoscopic image display device includes a touch panel provided on the screen, the enlargement instruction receiving unit acquires information indicating contacts of two objects on the touch panel, respective movements from contact points of the two objects, and movement destinations of the two objects, from the touch panel, and receives the enlargement instruction based on the information, and the enlargement display control unit causes, during the enlargement instruction period, causes the enlarged stereoscopic image in the enlarged scale at the magnification at which the parallax amount equals the threshold value to be displayed in vibration within the screen of the stereoscopic image display device, and acquires a movement direction starting from the contact points of the two objects from the information so that a vibration direction of the enlarged stereoscopic image within the screen substantially matches the movement direction.

In the disclosed stereoscopic image display control device, when the enlargement instruction for enlarging the stereoscopic image beyond the magnification at which the parallax amount equals the threshold value is made, the enlargement display control unit causes the enlarged stereoscopic image in the enlarged scale at the magnification according to the enlargement instruction to be displayed on the stereoscopic image display device during the enlargement instruction, and causes the enlarged stereoscopic image in the enlarged scale at the magnification at which the parallax amount is not greater than the threshold value to be displayed on the stereoscopic image display device when the enlargement instruction is finished.

In the disclosed stereoscopic image display control device, when the enlargement instruction is finished, the enlargement display control unit causes the enlarged stereoscopic image displayed on the stereoscopic image display device to be gradually reduced, and finally causes the stereoscopic image in the enlarged scale at the magnification at which the parallax amount is not greater than the threshold value to be displayed on the stereoscopic image display device.

The disclosed stereoscopic image display control device, further includes: an observer information acquiring unit that acquires information on an observer of the stereoscopic image display device; and a threshold value setting unit that sets the threshold value according to the information on the observer acquired by the observer information acquiring unit.

The disclosed stereoscopic image display control device, further includes: a first information display control unit that causes information indicating an allowable magnification allowing the parallax amount to be the threshold value or less to be displayed on the stereoscopic image display device.

The disclosed stereoscopic image display control device, further includes: a second information display control unit that causes information indicating an optimum magnification allowing the parallax amount to be an optimum value for stereoscopic vision to be displayed on the stereoscopic image display device.

In the disclosed stereoscopic image display control device, the parallax amount of the enlarged stereoscopic image is any one of a parallax amount of a main subject included in the enlarged stereoscopic image, a maximum value of parallax amounts of subjects included in the enlarged stereoscopic image, a peak value of a histogram of the parallax amounts of the subjects included in the enlarged stereoscopic image, and an average value of the parallax amounts of the subjects included in the enlarged stereoscopic image.

It is disclosed an imaging apparatus including: the stereoscopic image display control device; the stereoscopic image display device; an imaging unit that captures a subject; and an image processing unit that generates the plurality of image data from a plurality of image signals captured by the imaging unit.

It is disclosed a stereoscopic image display control method for causing a stereoscopic image based on a. plurality of image data photographed at different viewpoints to be displayed on a stereoscopic image display device, the method including: an enlargement instruction receiving step of receiving an enlargement instruction for enlarging the stereoscopic image displayed on the stereoscopic image display device; an enlargement display control step of causing the stereoscopic image to be displayed in an enlarged scale according to the enlargement instruction on the stereoscopic image display device; and a parallax amount determination step of determining, when the stereoscopic image is enlarged at a magnification according to the enlargement instruction, whether or not a parallax amount of the enlarged stereoscopic image displayed on the stereoscopic image display device is greater than a threshold value, in which in the enlargement display control step, when the enlargement instruction for enlarging the stereoscopic image at the magnification at which the parallax amount is greater than the threshold value is made, the enlarged stereoscopic image to be displayed on the stereoscopic image display device after the enlargement instruction is finished becomes the enlarged stereoscopic image in the enlarged scale at the magnification at which the parallax amount is not greater than the threshold value.

### INDUSTRIAL APPLICABILITY

The present invention may be effectively applicable to, for example, a digital camera or a TV.

The present invention has been described by specific exemplary embodiments, but is not limited thereto. Various modifications may be made within the technical spirit of the disclosed invention.

The present application is based on Japanese Patent Application (No. 2012-37646) filed on Feb. 23, 2012, the contents of which are incorporated herein,

### REFERENCE SIGNS LIST

11 System Control Unit
23 Stereoscopic Image Display Device

What is claimed is:

1. A stereoscopic image display control device which causes a stereoscopic image based on a plurality of image data photographed at different viewpoints to be displayed on a stereoscopic image display device, comprising:
an enlargement instruction receiving unit that receives an enlargement instruction for enlarging the stereoscopic image displayed on the stereoscopic image display device;
an enlargement display control unit that causes the stereoscopic image to be displayed in an enlarged scale according to the enlargement instruction on the stereoscopic image display device; and
a parallax amount determination unit that determines, when the stereoscopic image is enlarged at a magnification according to the enlargement instruction, whether or not a parallax amount of the enlarged stereoscopic image displayed on the stereoscopic image display device is greater than a threshold value.
wherein when the enlargement instruction for enlarging the stereoscopic image at the magnification at which the parallax amount is greater than the threshold value is made, the enlargement display control unit causes the enlarged stereoscopic image to be displayed on the stereoscopic image display device after the enlargement instruction is finished to become the enlarged stereoscopic image in the enlarged scale at the magnification at which the parallax amount is not greater than the threshold value.

2. The stereoscopic image display control device of claim 1, wherein during an enlargement instruction period in which the enlargement instruction for enlarging the stereoscopic image beyond the magnification at which the parallax amount equals the threshold value is being made, the enlargement display control unit stops enlargement processing according to the enlargement instruction, and causes the enlarged stereoscopic image in the enlarged scale at the magnification at which the parallax amount equals the threshold value to be displayed on the stereoscopic image display device in a display form different from a form of the stereoscopic image in the enlarged scale at the magnification at which the parallax amount is not greater than the threshold value.

3. The stereoscopic image display control device of claim 2, wherein the enlargement display control unit, during the enlargement instruction period, causes the enlarged stereoscopic image in the enlarged scale at the magnification at which the parallax amount equals the threshold value to be displayed in vibration within a screen of the stereoscopic image display device, or causes to be displayed in an enlarged scale and a reduced scale alternately and repeatedly.

4. The stereoscopic image display control device of claim 3, wherein the stereoscopic image display device includes a touch panel provided on the screen.
the enlargement instruction receiving unit acquires information indicating contacts of two objects on the touch panel, respective movements from contact points of the two objects, and movement destinations of the two objects, from the touch panel, and receives the enlargement instruction based on the information, and
the enlargement display control unit causes, during the enlargement instruction period, causes the enlarged stereoscopic image in the enlarged scale at the magnification at which the parallax amount equals the threshold value to be displayed in vibration within the screen of the stereoscopic image display device, and acquires a movement direction starting from the contact points of the two objects from the information so that a vibration direction of the enlarged stereoscopic image within the screen substantially matches the movement direction.

5. The stereoscopic image display control device of claim 1, wherein when the enlargement instruction for enlarging the stereoscopic image beyond the magnification at which the parallax amount equals the threshold value is made, the enlargement display control unit causes the enlarged stereoscopic image in the enlarged scale at the magnification according to the enlargement instruction to be displayed on the stereoscopic image display device during the enlargement instruction, and causes the enlarged stereoscopic image in the enlarged scale at the magnification at which the parallax amount is not greater than the threshold value to be displayed on the stereoscopic image display device when the enlargement instruction is finished.

6. The stereoscopic image display control device of claim 5, wherein when the enlargement instruction is finished, the enlargement display control unit causes the enlarged stereoscopic image displayed on the stereoscopic image display device to be gradually reduced, and finally causes the stereoscopic image in the enlarged scale at the magnification at which the parallax amount is not greater than the threshold value to be displayed on the stereoscopic image display device.

7. The stereoscopic image display control device of claim 1, further comprising:
an observer information acquiring unit that acquires information on an observer of the stereoscopic image display device; and
a threshold value setting unit that sets the threshold value according to the information on the observer acquired by the observer information acquiring unit.

8. The stereoscopic image display control device of claim 1, further comprising:
a first information display control unit that causes information indicating an allowable magnification allowing the parallax amount to be the threshold value or less to be displayed on the stereoscopic image display device.

9. The stereoscopic image display control device of claim 1, further comprising:
a second information display control unit that causes information indicating an optimum magnification allowing the parallax amount to be an optimum value for stereoscopic vision to be displayed on the stereoscopic image display device.

10. The stereoscopic image display control device of claim 1, wherein the parallax amount of the enlarged stereoscopic image is any one of a parallax amount of a main subject included in the enlarged stereoscopic image, a maximum value of parallax amounts of subjects included in the enlarged stereoscopic image, a peak value of a histogram of the parallax amounts of the subjects included in the enlarged stereoscopic image, and an average value of the parallax amounts of the subjects included in the enlarged stereoscopic image.

11. An imaging apparatus comprising:
the stereoscopic image display control device of claim 1;
the stereoscopic image display device;
an imaging unit that captures a subject; and
an image processing unit that generates the plurality of image data from a plurality of image signals captured by the imaging unit.

12. A stereoscopic image display control method for causing a stereoscopic image based on a plurality of image data photographed at different viewpoints to be displayed on a stereoscopic image display device, the method comprising:
an enlargement instruction receiving step of receiving an enlargement instruction for enlarging the stereoscopic image displayed on the stereoscopic image display device;
an enlargement display control step of causing the stereoscopic image to be displayed in an enlarged scale according to the enlargement instruction on the stereoscopic image display device; and
a parallax amount determination step of determining, when the stereoscopic image is enlarged at a magnification according to the enlargement instruction, whether or not a parallax amount of the enlarged stereoscopic image displayed on the stereoscopic image display device is greater than a threshold value,
wherein in the enlargement display control step, when the enlargement instruction for enlarging the stereoscopic image at the magnification at which the parallax amount is greater than the threshold value is made, the enlarged stereoscopic image to be displayed on the stereoscopic image display device after the enlargement instruction is finished becomes the enlarged stereoscopic image in the enlarged scale at the magnification at which the parallax amount is not greater than the threshold value.
